(19) United States
(12) Patent Application Publication
(10) Pub. No.: US 2023/0110125 A1
(43) Pub. Date: Apr. 13, 2023

(54) HEATER STRUCTURE

(71) Applicant: Cheng Uei Precision Industry Co., LTD., New Taipei City (TW)

(72) Inventors: JIN-HUAI MO, Dong-Guan City (CN); MING-XU JIANG, Dong-Guan City (CN)

(21) Appl. No.: 17/885,485

(22) Filed: Aug. 10, 2022

(30) Foreign Application Priority Data
Oct. 11, 2021 (CN) 202122445199.7

(51) Int. Cl. F24C 7/00; F24C 7/06; F24C 15/08

(52) U.S. Cl. CPC F24C 7/002; F24C 7/062; F24C 15/08

(57) ABSTRACT

A heater structure includes a heating unit, a power supply holder, a second conducting element, a locking component, a docking component, a printed circuit board and an identification circuit. The heating unit includes a heating container, a first conducting element and a locking component. The power supply holder has a housing. The housing is connected with an extending wall. The housing is cooperated with the extending wall to define an inner space for accommodating the heating unit. A peripheral wall of the housing is recessed downward and sideward to form a locking groove. The second conducting element is mounted in the inner space. The second conducting element is connected with the first conducting element. The locking component is locked in the locking groove. The docking component is disposed in the inner space. The printed circuit board is mounted to a bottom of the power supply holder.

### CROSS-REFERENCE TO RELATED APPLICATION

The present application is based on, and claims priority from, China Patent Application No. 202122445199.7, filed Oct. 11, 2021, the disclosure of which is hereby incorporated by reference herein in its entirety.

### BACKGROUND OF THE INVENTION

### 1. Field of the Invention

The present invention generally relates to a heater structure, and more particularly to a heater structure which has a compact size, and an automatic heating mode selection function to heat different contents with different heating modes.

### 2. The Related Art

A conventional heater structure on the market is electrically connected with a power supply holder. The conventional heater structure is assembled on the power supply holder for realizing a single heating mode, and contents in the conventional heater structure is heated in a predefined heating process. However, the single heating mode of the conventional heater structure is unable to satisfy diverse needs of people, in order to make the power supply holder automatically identify different heater structures, and the different heater structures use different heating modes to heat different contents in the different heater structures. Moreover, some of the different heater structures are designed with different sensors, the different sensors generally include hall sensors and photoelectric sensors, a design of the conventional heater structure needs a larger space and a specific material, consequently, a cost of the conventional heater structure is increased, and the conventional heater structure is difficult to appropriate for a small size requirement.

Therefore, it is necessary to provide a heater structure which has a compact size, and an automatic heating mode selection function to heat different contents with different heating modes.

### SUMMARY OF THE INVENTION

An object of the present invention is to provide a heater structure. The heater structure includes a heating unit, a power supply holder, a second conducting element, a locking component, a docking component, a printed circuit board and an identification circuit. The heating unit includes a heating container for containing contents which are to be heated, a first conducting element connected with the heating container, a contacting section protruded inward from an inner surface of the heating unit, a metal case mounted around an outside of the heating container, a locking component mounted on an outer surface of the metal case, and a conductive component protruded outward from an outer periphery of the metal case. The conductive component has different electrical properties. Each electrical property of the conductive component is distinctive. The power supply holder has a housing. The housing is disposed vertically, and a top and a bottom of the housing are opened freely. A periphery of the bottom of the housing is connected with an extending wall. The housing is cooperated with the extending wall to define an inner space inside the power supply holder. The inner space is used for accommodating the heating unit. A top of a peripheral wall of the housing is recessed downward and sideward to form a locking groove. The locking groove is communicated with the inner space. The second conducting element is mounted in the inner space. The second conducting element is connected with the first conducting element. The locking component is locked in the locking groove. The docking component is disposed in the inner space. The docking component is electrically connected with the conductive component. The printed circuit board is mounted to a bottom of the power supply holder. The printed circuit board is integrated with a signal component and a measuring component. The printed circuit board is connected with the signal component, the conductive component and the measuring component to form the identification circuit.

Another object of the present invention is to provide a heater structure. The heater structure includes a heating unit, a power supply holder, a second conducting element, a locking component, a docking component, a printed circuit board and an identification circuit. The heating unit includes a metal case forming an outer structure of the heating unit, a heating container for containing contents which are to be heated, a first conducting element connected with the heating container, a locking component mounted on an outer surface of the metal case, a contacting section protruded inward from an inner surface of the heating unit, and a conductive component protruded outward from an outer periphery of the metal case, the conductive component being a metal layer. The metal case is mounted around an outside of the heating container. The metal layer surrounds an outer surface of the contacting section. The metal layer is protruded outward from the outer surface of the metal case. The metal layer is formed in a circular shape. The power supply holder has an inner space for accommodating the heating unit. The power supply holder has a locking groove penetrating through a top of the power supply holder. The locking groove is communicated with the inner space. The second conducting element is mounted in the inner space. The second conducting element is connected with the first conducting element. The locking component is locked in the locking groove. The docking component is disposed in the inner space. The docking component is electrically connected with the conductive component. The printed circuit board is mounted to a bottom of the power supply holder. The printed circuit board is integrated with a signal component and a measuring component. The printed circuit board is connected with the signal component, the conductive component and the measuring component to form the identification circuit.

Another object of the present invention is to provide a heater structure. The heater structure includes a heating unit, a power supply holder, a second conducting element, a locking component, a docking component, a printed circuit board and an identification circuit. The heating unit includes a metal case forming an outer structure of the heating unit, a heating container for containing contents which are to be heated, a first conducting element connected with the heating container, a locking component mounted on an outer surface of the metal case, a contacting section protruded inward from an inner surface of the heating unit, and a conductive component recessed inward from an outer periphery of the metal case. The metal case is mounted around an outside of the heating container. The conductive component is an air layer. The air layer is recessed inward from the outer surface of the metal case. The air layer surrounds an outer surface of the contacting section. The air layer is formed in a circular shape. The power supply holder has an inner space for accommodating the heating unit. The power supply holder has a locking groove penetrating through a top of the power supply holder. The locking groove is communicated with the inner space. The second conducting element is mounted in the inner space. The second conducting element is connected with the first conducting element. The locking component is locked in the locking groove. The docking component is disposed in the inner space. The docking component is electrically connected with the conductive component. The printed circuit board is mounted to a bottom of the power supply holder. The printed circuit board is integrated with a signal component and a measuring component. The identification circuit is conductive with the printed circuit board, the signal component, the conductive component and the measuring component.

As described above, the metal layer and the air layer are both formed in circular shapes, so when the heater structure is assembled, the metal layer or the air layer has no need of being deliberately aligned to the elastic section.

### BRIEF DESCRIPTION OF THE DRAWINGS

The present invention will be apparent to those skilled in the art by reading the following description, with reference to the attached drawings, in which:

FIG. 1 is a perspective view of a heater structure in accordance with the present invention;

FIG. 2 is an exploded view of the heater structure of FIG. 1;

FIG. 3 is a perspective view of a power supply holder in accordance with the present invention;

FIG. 4 is a sectional view of the heater structure in accordance with a first preferred embodiment of the present invention;

FIG. 5 is an enlarged view of an encircled portion V of the heater structure shown in FIG. 4;

FIG. 6 is a sectional view of a heating unit of FIG. 4;

FIG. 7 is a sectional view of the heater structure in accordance with a second preferred embodiment of the present invention;

FIG. 8 is an enlarged view of an encircled portion VIII of the heater structure shown in FIG. 7;

FIG. 9 is a perspective view of the heating unit of the heater structure in accordance with the second preferred embodiment of the present invention; and

FIG. 10 is a block diagram of an identification circuit of the heater structure according to the present invention.

### DETAILED DESCRIPTION OF THE PREFERRED EMBODIMENT

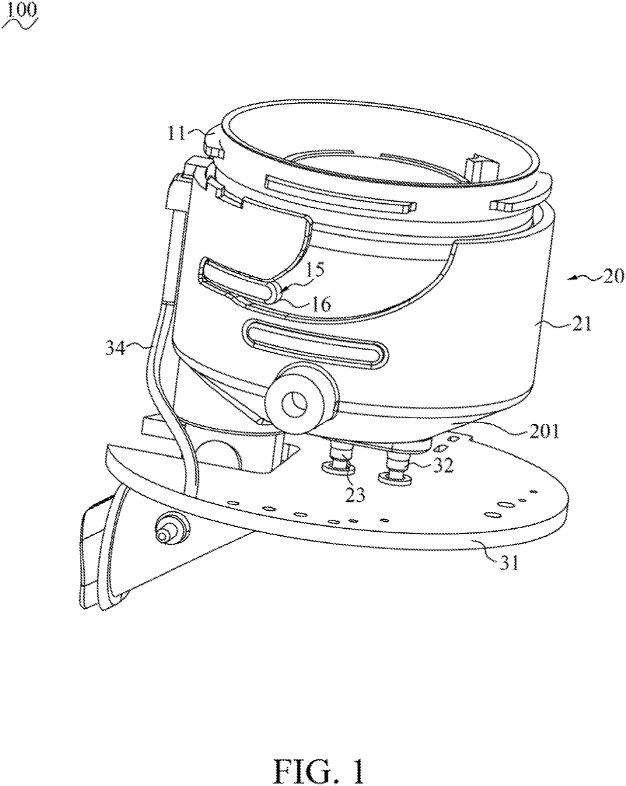

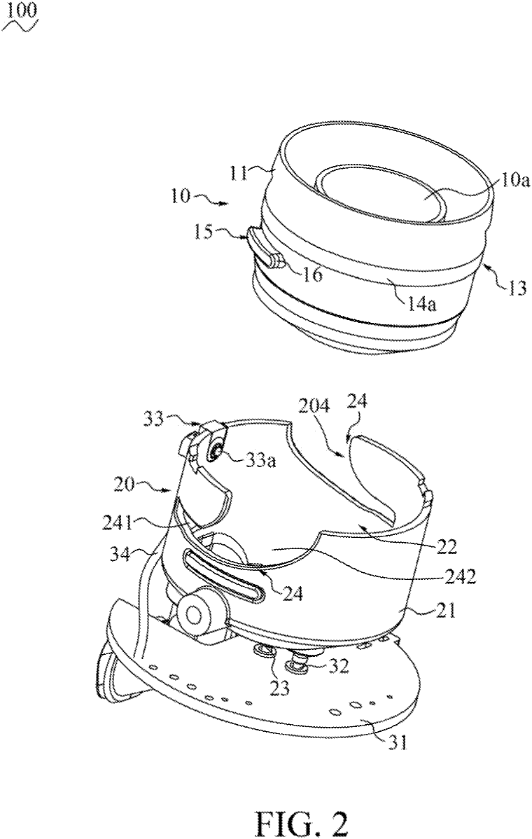

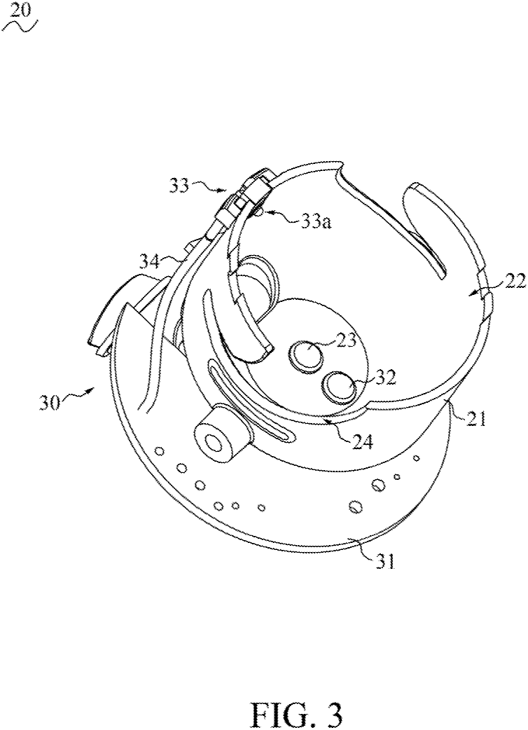

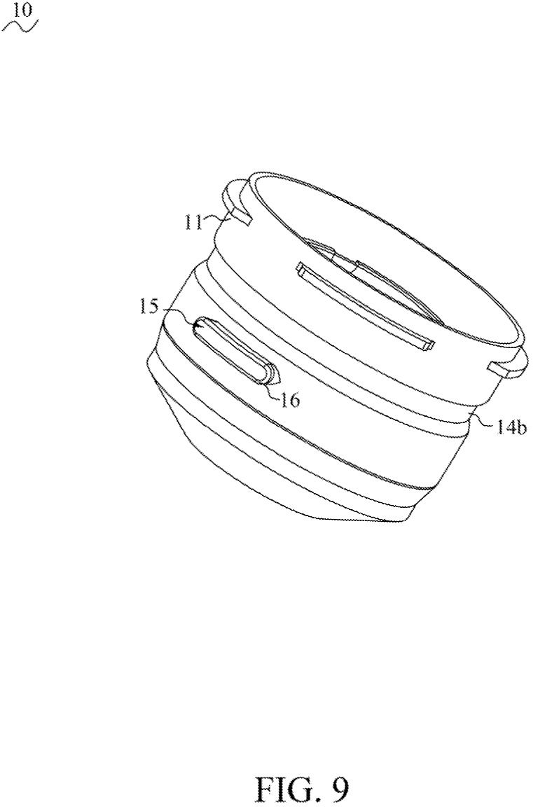

Referring to FIG. 1, FIG. 2, FIG. 3 and FIG. 9, a heater structure 100 in accordance with a first preferred embodiment and a second preferred embodiment of the present invention is shown. The heater structure 100 includes a heating unit 10, a power supply holder 20 and an identification circuit 30.

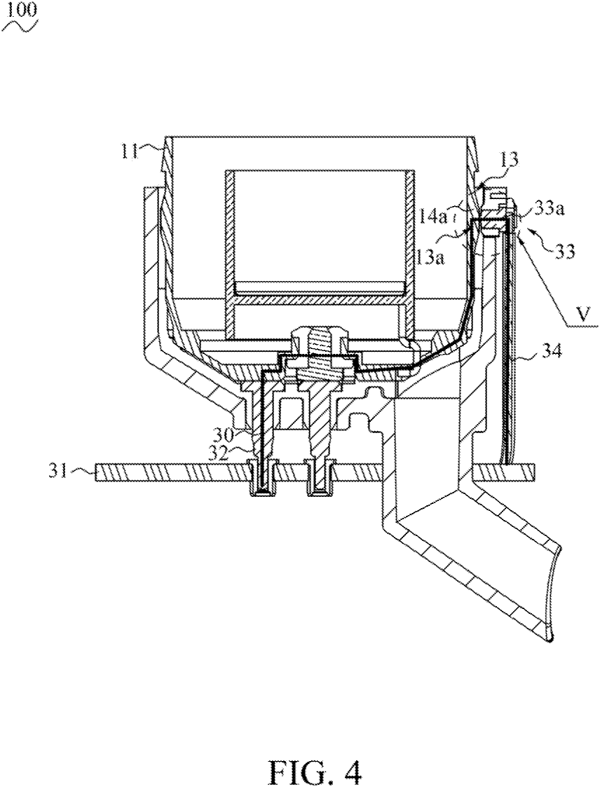

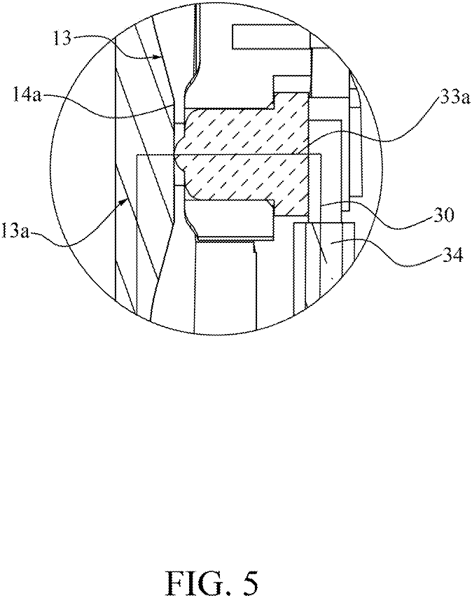

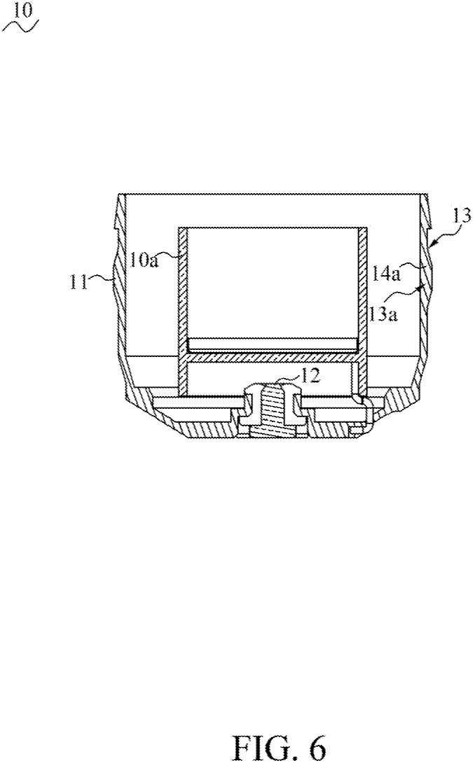

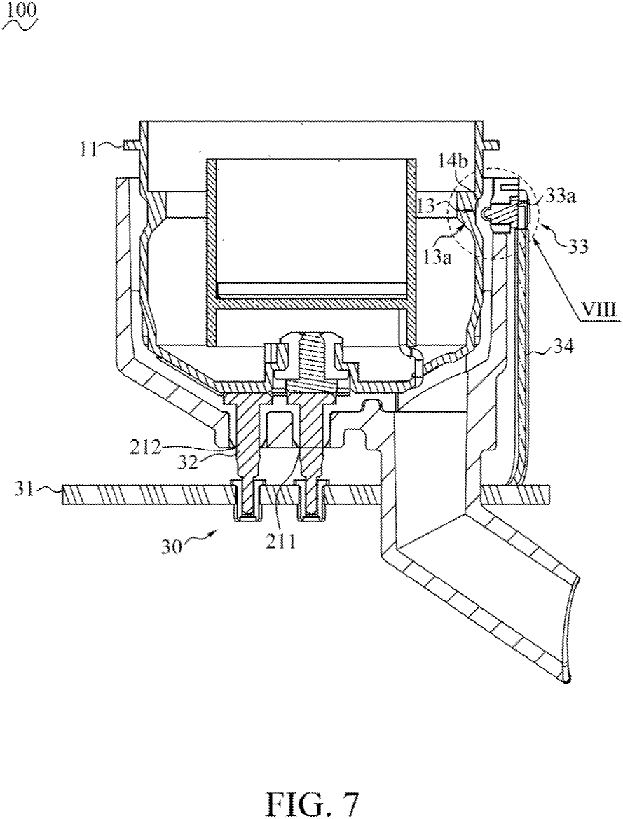

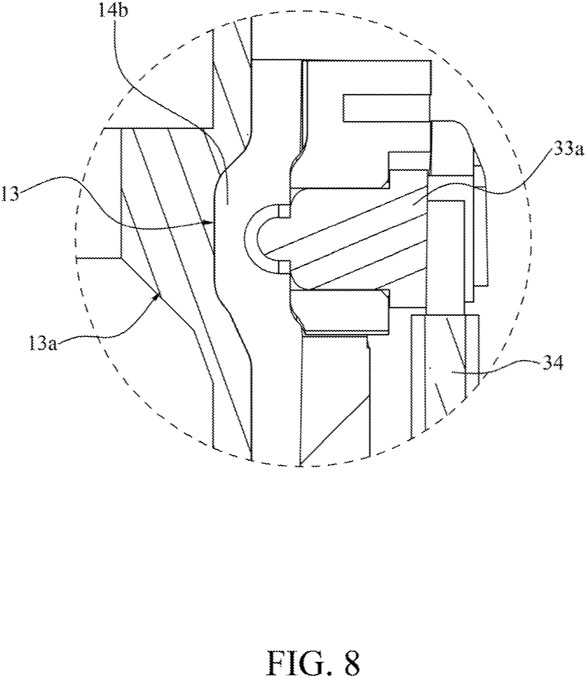

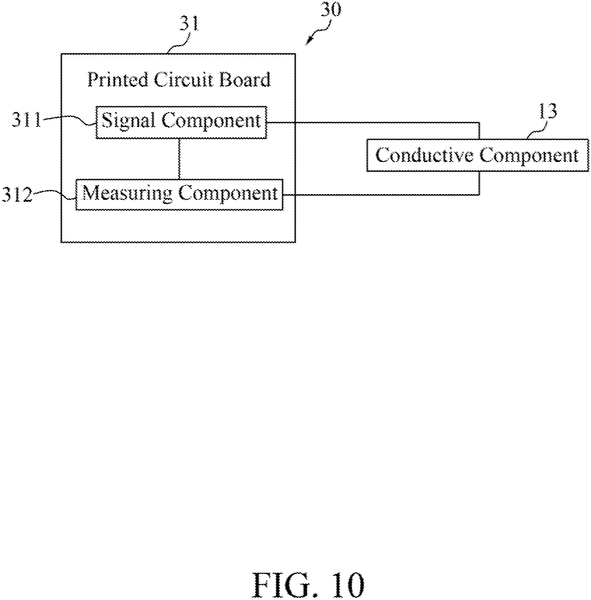

Referring to FIG. 1 to FIG. 10, the heating unit 10 includes a heating container 10a, a first conducting element 12, a conductive component 13, a metal case 11 and a contacting section 13a. The metal case 11 is cylindrical.

The heating container 10a is used for containing contents which are to be heated. The first conducting element 12 is connected with the heating container 10a. The conductive component 13 is mounted around an outer periphery of the heating unit 10. The conductive component 13 has different electrical properties. Each electrical property of the conductive component 13 is distinctive. The conductive component 13 is formed around an outer periphery of the metal case 11. The metal case 11 forms an outer structure of the heating unit 10. The conductive component 13 is protruded outward from the outer periphery of the metal case 11. The metal case 11 is mounted around an outside of the heating container 10a, and the metal case 11 is separated from the heating container 10a. The contacting section 13a is a ring shape. The contacting section 13a is protruded inward from an inner periphery of the metal case 11. The heating container 10a is equipped with a heating wire (not shown). The heating wire is a resistance wire. The resistance wire is arranged in a wall of the heating container 10a. The resistance wire is arranged around the wall of the heating container 10a. The contacting section 13a is protruded inward from an inner surface of the heating unit 10.

The power supply holder 20 has a housing 21 and an inner space 22. The housing 21 is a hollow cylinder shape. The housing 21 is disposed vertically, and a top and a bottom of the housing 21 are opened freely. A periphery of the bottom of the housing 21 is connected with an obconical extending wall 201. The extending wall 201 gradually tapers from a top of the extending wall 201 to a bottom of the extending wall 201. The housing 21 is cooperated with the extending wall 201 to define the inner space 22 inside the power supply holder 20. The inner space 22 is used for accommodating the heating unit 10. The heater structure 100 further includes a second conducting element 23. The second conducting element 23 is mounted in the inner space 22. The second conducting element 23 is connected with the first conducting element 12. A center and one side of the bottom of the housing 21 define a first insertion hole 211 and a second insertion hole 212 vertically penetrating through the bottom of the housing 21.

The heater structure 100 further includes a docking component 33. The docking component 33 is disposed in the inner space 22. The docking component 33 is corresponding to the conductive component 13. The docking component 33 is electrically connected with the conductive component 13. The docking component 33 and the conductive component 13 are conductive. The heater structure 100 further includes a printed circuit board 31. The printed circuit board 31 is mounted to a bottom of the power supply holder 20. The printed circuit board 31 is integrated with a signal component 311 and a measuring component 312. The printed circuit board 31 is with a signal transmitting function and a measuring function.

Referring to FIG. 1 to FIG. 6, in order to ensure that the heating unit 10 is fastened to the power supply holder 20 and is powered by the power supply holder 20, the heating unit 10 includes a locking component 15, and the locking component 15 is mounted on an outer surface of the metal case 11. The power supply holder 20 has a locking groove 24 penetrating through a top of the power supply holder 20. A top of a peripheral wall of the housing 21 is recessed downward and sideward to form the locking groove 24. The locking groove 24 is a substantially arc shape. The locking groove 24 gradually becomes narrower from a top of the locking groove 24 to a bottom of the locking groove 24. The locking groove 24 is communicated with the inner space 22. The locking groove 24 penetrates through the peripheral wall of the housing 21 along radial directions of the housing 21. The locking component 15 is locked in the locking groove 24.

The locking component 15 has at least two latches 16. The at least two latches 16 are protruded outward from the outer surface of the metal case 11. Specifically, two opposite ends of the locking component 15 has two latches 16. The two latches 16 are symmetrical with respect to a center of the locking component 15. The two latches 16 are protruded outward from the outer surface of the metal case 11. The locking groove 24 has at least two limiting positions 204 matched with the at least two latches 16. Two opposite ends of the locking groove 24 are defined as a first limiting position 241 and a second limiting position 242. The at least two limiting positions 204 include the first limiting position 241 and the second limiting position 242. The first limiting position 241 and the second limiting position 242 are matched with the two latches 16. The first limiting position 241 and the second limiting position 242 are cooperated with the two latches 16.

When the heating unit 10 is assembled to the power supply holder 20, the two latches 16 of the locking component 15 slide between the first limiting position 241 and the second limiting position 242 of the locking groove 24 by rotating the heating unit 10, and the two latches 16 are locked to the first limiting position 241 of the locking groove 24, or the two latches 16 are limited to the second limiting position 242 of the locking groove 24. When the two latches 16 are locked to the first limiting position 241 of the locking groove 24, the heating unit 10 is fastened to the power supply holder 20. When the two latches 16 are limited to the second limiting position 242 of the locking groove 24, the two latches 16 are able to move upward away from the second limiting position 242 of the locking groove 24, so the heating unit 10 is loosened from the power supply holder 20.

Preferably, the heating unit 10 includes two locking components 15. The power supply holder 20 has two locking grooves 24. Each locking component 15 is locked in one locking groove 24. The two opposite ends of each locking component 15 has the two latches 16. The two latches 16 of each locking component 15 are symmetrical with respect to the center of each locking component 15. Each locking groove 24 has the at least two limiting positions 204 matched with the at least two latches 16 of one locking component 15. The two opposite ends of each locking groove 24 are defined as the first limiting position 241 and the second limiting position 242. The at least two limiting positions 204 of each locking groove 24 include the first limiting position 241 and the second limiting position 242. The first limiting position 241 and the second limiting position 242 of each locking groove 24 are matched with the two latches 16 of the one locking component 15. The first limiting position 241 and the second limiting position 242 of each locking groove 24 are cooperated with the two latches 16 of the one locking component 15.

When the heating unit 10 is assembled to the power supply holder 20, the two latches 16 of each locking component 15 slide between the first limiting position 241 and the second limiting position 242 of the one locking groove 24 by rotating the heating unit 10, and the two latches 16 of each locking component 15 are locked to the first limiting position 241 of the one locking groove 24, or the two latches 16 of each locking component 15 are limited to the second limiting position 242 of the one locking groove 24. When the two latches 16 of each locking component 15 are locked to the first limiting position 241 of the one locking groove 24, the heating unit 10 is fastened to the power supply holder 20. When the two latches 16 of each locking component 15 are limited to the second limiting position 242 of the one locking groove 24, the two latches 16 of each locking component 15 are able to move upward away from the second limiting position 242 of the one locking groove 24, so the heating unit 10 is loosened from the power supply holder 20.

Referring to FIG. 1 to FIG. 10, meanwhile, the second conducting element 23 is mounted at a center of the bottom of the power supply holder 20. The second conducting element 23 is a terminal. One end of the second conducting element 23 is connected with the printed circuit board 31, and the other end of the second conducting element 23 is connected to the power supply holder 20. The other end of the second conducting element 23 projects beyond a bottom surface of the power supply holder 20 through the first insertion hole 211, so that the other end of the second conducting element 23 contacts with the first conducting element 12 well.

The identification circuit 30 is formed by a plurality of connected parts which are mounted to the heating unit 10 and the power supply holder 20. The printed circuit board 31 is connected with the signal component 311, the conductive component 13 and the measuring component 312 to form the identification circuit 30. The identification circuit 30 is conductive with the printed circuit board 31, the signal component 311, the conductive component 13 and the measuring component 312. The identification circuit 30 is started from an original end of the printed circuit board 31, the signal component 311, the printed circuit board 31 and the conductive component 13 are conductive in sequence, and then the identification circuit 30 returns to the original end of the printed circuit board 31, and the original end of the printed circuit board 31 is connected with the measuring component 312.

Referring to FIG. 1 to FIG. 10, a current is transmitted through the identification circuit 30. A current transmitting path of the identification circuit 30 passes through the conductive component 13. Different heating containers 10a are able to be used to different heating units 10, the different heating containers 10a are equipped with different conductive components 13. The different conductive components 13 have the different electrical properties. The different conductive components 13 have different active or passive electrical properties, and the different heating units 10 are identified by measuring the different active or passive electrical properties, so different heating modes are provided for the different heating units 10. The different active or passive electrical properties include resistance values of the different conductive components 13, capacitance values of the different conductive components 13, etc. The conductive component 13 is connected to the identification circuit 30 in series, nevertheless, the conductive component 13 is without being connected to the identification circuit 30 in series. Preferably, the conductive component 13 is connected to the identification circuit 30 in a parallel connection way. Therefore, the heater structure 100 identifies a type of the heating unit 10 which is installed to the power supply holder 20 by measuring the electrical properties of the conductive component 13 with the measuring component 312 and a function of the identification circuit 30, and then heat the heating unit 10 in a corresponding heating mode.

Referring to FIG. 1 to FIG. 3, in the first preferred embodiment and the second preferred embodiment, two different types of the heating units 10 are identified by use of the electrical properties of switching a closed circuit state and an open circuit state of the identification circuit 30.

Referring to FIG. 1 to FIG. 10, the identification circuit 30 includes a third conducting element 32, a metal case 11, an elastic section 33a and a cable 34. The third conducting element 32 is connected with the printed circuit board 31. The third conducting element 32 is conductive with the printed circuit board 31. The metal case 11 is connected with the third conducting element 32 and the conductive component 13. The metal case 11 is conductive with the third conducting element 32 and the conductive component 13. The elastic section 33a is secured to the housing 21, and the elastic section 33a is connected with the conductive component 13. The elastic section 33a is conductive with the conductive component 13. The cable 34 is connected with the elastic section 33a and the printed circuit board 31. The cable 34 is conductive with the elastic section 33a and the printed circuit board 31. The contacting section 13a is disposed as the elastic section 33a cooperated with the outer surface of the metal case 11, the elastic section 33a is connected with the outer surface of the metal case 11.

The elastic section 33a is a pogo pin. The conductive component 13 is mounted to an outer wall of the metal case 11. The conductive component 13 is a metal layer 14a. The metal layer 14a surrounds an outer surface of the contacting section 13a. The metal layer 14a is protruded outward from the outer surface of the metal case 11. The metal layer 14a is corresponding to the elastic section 33a. The metal layer 14a is coupled with the elastic section 33a. When the heating unit 10 is inserted into the inner space 22, one end of the elastic section 33a passes through a wall of the housing 21, the one end of the elastic section 33a abuts against the metal layer 14a, and the one end of the elastic section 33a contacts with the metal layer 14a, so the identification circuit 30 is in a connected state, and the identification circuit 30 is in an on-state.

A current signal which is emitted by the signal component 311 passes through the printed circuit board 31, the third conducting element 32, the metal case 11, the metal layer 14a and the elastic section 33a, and then the current signal flows back to the printed circuit board 31 via the cable 34 to form a circuit current, the circuit current is able to be detected by the measuring component 312, and then the heater structure 100 adopts a heating mode corresponding to the on-state of the identification circuit 30.

The conductive component 13 is recessed inward and opposite to the inner space 22 from the outer periphery of the metal case 11. The conductive component 13 is an air layer 14b. The air layer 14b surrounds an outer surface of the contacting section 13a. Preferably, the air layer 14b is recessed inward and opposite to the inner space 22 from the outer surface of the metal case 11. A thickness of the air layer 14b is greater than a movable stroke of the elastic section 33a along a radial direction of the housing 21, so when the elastic section 33a is in a fully extension status, the elastic section 33a is unable to be connected with the metal case 11. The metal case 11 is isolated from the elastic section 33a by the air layer 14b, so that the identification circuit 30 is in a disconnected status, and the identification circuit 30 is in an off-state.

After the current signal which is emitted by the signal component 311 passes through the printed circuit board 31, the third conducting element 32, the metal case 11 and the air layer 14b in sequence, and then the elastic section 33a is isolated from the metal case 11 by the air layer 14b, so the identification circuit 30 is in the disconnected status, and the identification circuit 30 is in the off-state. The current signal which is emitted from the signal component 311 is unable to be detected by the measuring component 312, and then the heater structure 100 adopts a heating mode corresponding to the off-state of the identification circuit 30.

Referring to FIG. 1 to FIG. 9, in order to promote a convenience of a user, the metal layer 14a and the air layer 14b are both designed in circular shapes, so when the user assembles the heating unit 10 with the power supply holder 20, the metal layer 14a or the air layer 14b has no need of being deliberately aligned to a direction of the elastic section 33a.

As described above, the metal layer 14a and the air layer 14b are both formed in the circular shapes, so when the heater structure 100 is assembled, the metal layer 14a or the air layer 14b has no need of being deliberately aligned to the elastic section 33a.

What is claimed is:

1. A heater structure, comprising:
a heating unit including a heating container for containing contents which are to be heated, a first conducting element connected with the heating container, a contacting section protruded inward from an inner surface of the heating unit, a metal case mounted around an outside of the heating container, a locking component mounted on an outer surface of the metal case, and a conductive component protruded outward from an outer periphery of the metal case, the conductive component having different electrical properties, each electrical property of the conductive component being distinctive;
a power supply holder having a housing, the housing being disposed vertically, and a top and a bottom of the housing being opened freely, a periphery of the bottom of the housing being connected with an extending wall, the housing being cooperated with the extending wall to define an inner space inside the power supply holder, the inner space being used for accommodating the heating unit, a top of a peripheral wall of the housing being recessed downward and sideward to form a locking groove, the locking groove being communicated with the inner space;
a second conducting element mounted in the inner space, the second conducting element being connected with the first conducting element;
a locking component locked in the locking groove;
a docking component disposed in the inner space, the docking component being electrically connected with the conductive component;
a printed circuit board mounted to a bottom of the power supply holder, the printed circuit board being integrated with a signal component and a measuring component; and
an identification circuit, the printed circuit board being connected with the signal component, the conductive component and the measuring component to form the identification circuit.

2. The heater structure as claimed in claim 1, wherein the metal case forms an outer structure of the heating unit, the metal case is separated from the heating container, the conductive component is formed around the outer periphery of the metal case.

3. The heater structure as claimed in claim 1, wherein the identification circuit includes a third conducting element, an elastic section and a cable, the third conducting element is connected with the printed circuit board, the third conducting element is conductive with the printed circuit board, the metal case is connected with the third conducting element and the conductive component, the metal case is conductive with the third conducting element and the conductive component, the elastic section is secured to the housing, and the elastic section is connected with the conductive component, the elastic section is conductive with the conductive component, the cable is connected with the elastic section and the printed circuit board, the cable is conductive with the elastic section and the printed circuit board.

4. The heater structure as claimed in claim 1, wherein the locking component has at least two latches, the at least two latches are protruded outward from the outer surface of the metal case, the locking groove has at least two limiting positions matched with the at least two latches.

5. The heater structure as claimed in claim 1, wherein two opposite ends of the locking component has two latches, the two latches are protruded outward from the outer surface of the metal case, the two latches are symmetrical with respect to a center of the locking component, two opposite ends of the locking groove are defined as a first limiting position and a second limiting position, the first limiting position and the second limiting position are matched with the two latches, the first limiting position and the second limiting position are cooperated with the two latches.

6. The heater structure as claimed in claim 1, wherein the contacting section is protruded inward from an inner periphery of the metal case, the contacting section is disposed as an elastic section cooperated with the outer surface of the metal case, the elastic section is connected with the outer surface of the metal case.

7. The heater structure as claimed in claim 1, wherein the metal case is cylindrical, the contacting section is a ring shape.

8. The heater structure as claimed in claim 1, wherein the conductive component is a metal layer, the metal layer surrounds an outer surface of the contacting section, the metal layer is protruded outward from the outer surface of the metal case.

9. The heater structure as claimed in claim 1, wherein the conductive component is a metal layer, the metal layer surrounds an outer surface of the contacting section, the metal layer is protruded outward from the outer surface of the metal case.

10. The heater structure as claimed in claim 1, wherein the conductive component is an air layer, the air layer surrounds an outer surface of the contacting section, the air layer is recessed inward and opposite to the inner space from the outer surface of the metal case.

11. The heater structure as claimed in claim 10, wherein a thickness of the air layer is greater than a movable stroke of the elastic section.

12. The heater structure as claimed in claim 1, wherein the heating unit includes two locking components, the power supply holder has two locking grooves, each locking component is locked in one locking groove, two opposite ends of each locking component has two latches, the two latches of each locking component are symmetrical with respect to a center of each locking component, two opposite ends of each locking groove are defined as a first limiting position and a second limiting position, the first limiting position and the second limiting position of each locking groove are matched with the two latches of one locking component, the first limiting position and the second limiting position of each locking groove are cooperated with the two latches of the one locking component.

13. The heater structure as claimed in claim 12, wherein when the heating unit is assembled to the power supply holder, the two latches of each locking component slide between the first limiting position and the second limiting position of the one locking groove by rotating the heating unit, when the two latches of each locking component are locked to the first limiting position of the one locking groove, the heating unit is fastened to the power supply holder, when the two latches of each locking component are limited to the second limiting position of the one locking groove, the two latches of each locking component are able to move upward away from the second limiting position of the one locking groove, so the heating unit is loosened from the power supply holder.

14. A heater structure, comprising:
a heating unit including a metal case forming an outer structure of the heating unit, a heating container for containing contents which are to be heated, a first conducting element connected with the heating container, a locking component mounted on an outer surface of the metal case, a contacting section protruded inward from an inner surface of the heating unit, and a conductive component protruded outward from an outer periphery of the metal case, the metal case being mounted around an outside of the heating container, the conductive component being a metal layer, the metal layer surrounding an outer surface of the contacting section, the metal layer being protruded outward from the outer surface of the metal case, the metal layer being formed in a circular shape;
a power supply holder having an inner space for accommodating the heating unit, the power supply holder having a locking groove penetrating through a top of the power supply holder, the locking groove being communicated with the inner space;
a second conducting element mounted in the inner space, the second conducting element being connected with the first conducting element;
a locking component locked in the locking groove;
a docking component disposed in the inner space, the docking component being electrically connected with the conductive component;
a printed circuit board mounted to a bottom of the power supply holder, the printed circuit board being integrated with a signal component and a measuring component; and
an identification circuit, the printed circuit board being connected with the signal component, the conductive component and the measuring component to form the identification circuit.

15. A heater structure, comprising:
a heating unit including a metal case forming an outer structure of the heating unit, a heating container for containing contents which are to be heated, a first conducting element connected with the heating container, a locking component mounted on an outer surface of the metal case, a contacting section protruded inward from an inner surface of the heating unit, and a conductive component recessed inward from an outer periphery of the metal case, the metal case being mounted around an outside of the heating container, the conductive component being an air layer, the air layer being recessed inward from the outer surface of the metal case, the air layer surrounding an outer surface of the contacting section, the air layer being formed in a circular shape;
a power supply holder having an inner space for accommodating the heating unit, the power supply holder having a locking groove penetrating through a top of the power supply holder, the locking groove being communicated with the inner space;
a second conducting element mounted in the inner space, the second conducting element being connected with the first conducting element;
a locking component locked in the locking groove;
a docking component disposed in the inner space, the docking component being electrically connected with the conductive component;
a printed circuit board mounted to a bottom of the power supply holder, the printed circuit board being integrated with a signal component and a measuring component; and
an identification circuit conductive with the printed circuit board, the signal component, the conductive component and the measuring component.
